(19) United States
(12) Patent Application Publication
(10) Pub. No.: US 2025/0139716 A1
(43) Pub. Date: May 1, 2025

(54) COMPUTER-READABLE RECORDING MEDIUM STORING ESTIMATION PROGRAM, ESTIMATION METHOD, AND INFORMATION PROCESSING APPARATUS

(71) Applicant: Fujitsu Limited, Kawasaki-shi (JP)

(72) Inventor: Yoshinobu IIMURA, Kawasaki (JP)

(73) Assignee: Fujitsu Limited, Kawasaki-shi (JP)

(21) Appl. No.: 18/890,262

(22) Filed: Sep. 19, 2024

(30) Foreign Application Priority Data
Oct. 27, 2023 (JP) 2023-184866

(51) Int. Cl. G06Q 50/06

(52) U.S. Cl. CPC G06Q 50/06

(57) ABSTRACT

A non-transitory computer-readable recording medium stores an estimation program for causing a computer to execute a process including: approximating a first curve and a second curve that has one intersection point with the first curve in a first period to a first approximation expression and a second approximation expression that are linear functions that pass through the intersection point, respectively; generating a machine learning model by respectively performing training by using data of slopes and intercepts of the first approximation expression and the second approximation expression; and estimating an intersection point between the first curve and the second curve in a second period that corresponds to a period after the first period by using the trained machine learning model.

### CROSS-REFERENCE TO RELATED APPLICATION

This application is based upon and claims the benefit of priority of the prior Japanese Patent Application No. 2023-184866, filed on Oct. 27, 2023, the entire contents of which are incorporated herein by reference.

### FIELD

The embodiments discussed herein are related to a computer-readable recording medium storing an estimation program, an estimation method, and an information processing apparatus.

### BACKGROUND

A power exchange exists as an agent for power buying and selling between a power generation business operator and a power retail business operator. The power exchange mediates power buying and selling by a transaction system using a computer. A spot market is one of transactions conducted on the power exchange. In the spot market, the transaction system divides a day into measurement units such as 30 minutes, and receives a selling bid for power from the power generation business operator and a buying bid for power from the retail business operator for each transfer time slot having a length of the measurement unit. After completing acceptance of an order, the transaction system determines a contract price based on a status of the selling bid and a status of the buying bid.

Japanese Laid-open Patent Publication Nos. 2016-33801 and 2018-13934, U.S. Patent Application Publication No. 2004/0215529, and U.S. Pat. No. 10,936,947 are disclosed as related art.

### SUMMARY

According to an aspect of the embodiments, a non-transitory computer-readable recording medium stores an estimation program for causing a computer to execute a process including: approximating a first curve and a second curve that has one intersection point with the first curve in a first period to a first approximation expression and a second approximation expression that are linear functions that pass through the intersection point, respectively; generating a machine learning model by respectively performing training by using data of slopes and intercepts of the first approximation expression and the second approximation expression; and estimating an intersection point between the first curve and the second curve in a second period that corresponds to a period after the first period by using the trained machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a contract price estimation device according to a first embodiment;

FIG. 2 is a diagram for explaining generation of an initial function;

FIG. 3 is a diagram illustrating an example of time-series changes in values of a slope and an intercept of a demand initial function created by an initial function generation unit;

FIG. 4 is a diagram illustrating an example of time-series changes in the values of the slope and the intercept after smoothing;

FIG. 5 is a diagram for explaining creation of a demand approximation expression and a supply approximation expression;

FIG. 6 is a diagram illustrating an outline of estimation processing performed by an estimation unit;

FIG. 7 is a diagram illustrating a comparison of prediction errors between estimation by the contract price estimation device according to the first embodiment and estimation using a long short-term memory (LSTM) alone;

FIG. 8 is a flowchart of training processing of a demand curve model and a supply curve model in a training phase;

FIG. 9 is a flowchart of estimation processing by the contract price estimation device in an estimation phase;

FIG. 10 is a diagram illustrating a hardware configuration of the contract price estimation device according to the first embodiment;

FIG. 11 is a diagram illustrating an example of a configuration of a computer system according to a second embodiment; and

FIG. 12 is a block diagram of a bidding computer.

### DESCRIPTION OF EMBODIMENTS

A contract price and a contract amount are determined based on a supply curve indicating a relationship between an amount and a price of a selling order and a demand curve indicating a relationship between an amount and a price of a buying order. For this reason, when the supply curve and the demand curve in a specific transfer time slot may be estimated in advance, the contract price may be accurately estimated.

Accordingly, as a technique related to a power price, there are the following techniques. For example, a technique has been proposed in which a demand curve and a supply curve are calculated by using a selling contract rate function and a buying contract rate function obtained by performing spline regression on result values of contract prices with a selling contract rate and a buying contract amount as explanatory variables. A technique has been proposed in which a power price is predicted by using a plurality of prediction methods, and a power price predicted by a prediction method having a highest index value as an index of prediction accuracy among the plurality of prediction methods is set as a predicted value. A technique for providing a probabilistic evaluation of cost and risk by predicting a power retail price has been proposed. As a demand prediction technique, a technique has been proposed in which a stochastic demand prediction of a target article is generated by a recurrent neural network model trained by using a plurality of time-series demand observations.

However, in the related art, prediction accuracy of a demand curve or a supply curve for a future time slot is poor, and prediction accuracy of a contract price determined based on the demand curve and the supply curve is insufficient. The problem that the prediction accuracy of the contract price is insufficient also occurs in market transactions other than power transactions.

The disclosed technique is made in view of the foregoing, and an object thereof is to provide a computer-readable recording medium storing an estimation program, an estimation method, and an information processing apparatus that improve prediction accuracy of a contract price.

Embodiments of an estimation program, an estimation method, and an information processing apparatus disclosed herein are described in detail below based on the drawings. The following embodiments are not intended to limit the estimation program, the estimation method, and the information processing apparatus disclosed herein.

### First Embodiment

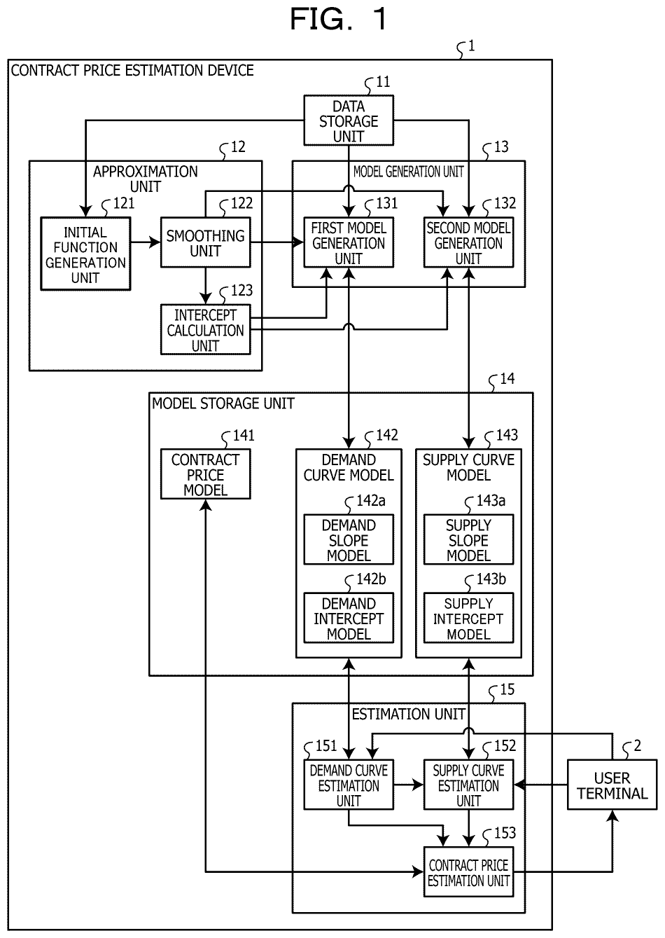

FIG. 1 is a block diagram of a contract price estimation device according to a first embodiment. As illustrated in FIG. 1, a contract price estimation device 1 according to the present embodiment includes a data storage unit 11, an approximation unit 12, a model generation unit 13, a model storage unit 14, and an estimation unit 15. The contract price estimation device 1 has two operation phases that are a training phase in which a demand curve model 142 and a supply curve model 143 included in the model storage unit 14 are trained and a training phase in which training about a contract price is performed by using the trained demand curve model 142 and the trained supply curve model 143.

For example, the data storage unit 11 stores information on a contract price, a demand curve, and a supply curve in each time slot of every 30 minutes in the past in a spot market. For example, the data storage unit 11 may hold a contract total amount, a selling bid price, and a buying bid price. The data storage unit 11 may also hold, for example, information on a temperature, a day of week, and a power use rate in each time slot. Hereinafter, the time slot of every 30 minutes is referred to as a measurement unit time slot.

For a first time slot which is a specific measurement time slot and a second time slot which is a measurement unit time slot before the first time slot, a data set including a demand curve and a supply curve in the first time slot and a contract price in the second time slot is used for training of the demand curve model 142 and the supply curve model 143.

The model storage unit 14 includes a contract price model 141, the demand curve model 142, and the supply curve model 143, which are machine learning models.

The demand curve model 142 is a machine learning model that receives a contract price in the second time slot as an input and outputs an estimated value of a value that defines an approximation expression of the demand curve in the first time slot. In the present embodiment, the demand curve model 142 includes a demand slope model 142a and a demand intercept model 142b.

The demand slope model 142a is a machine learning model that receives the contract price in the second time slot which is time-series data as an input and outputs an estimated value of a slope of a demand approximation expression obtained by approximating the demand curve in the first time slot for each second time slot to a linear function. This demand approximation expression is an example of a “first approximation expression”.

For example, the demand slope model 142a is a model using a recurrent neural network (RNN). For example, a long short-term memory (LSTM) network, which is a type of the RNN, may be used as the demand slope model 142a. The LSTM is good at learning and prediction (regression and classification) of time-series data.

The demand intercept model 142b is a machine learning model that receives the contract price in the second time slot which is time-series data as an input and outputs an estimated value of an intercept of the demand approximation expression obtained by approximating the demand curve in the first time slot for each second time slot to a linear function. For example, the demand intercept model 142b is a model using the RNN. For example, the demand intercept model 142b may use the LSTM network.

The supply curve model 143 is a machine learning model that receives the contract price in the second time slot as an input and outputs an estimated value of a value that defines an approximation expression of the supply curve in the first time slot. This supply approximation expression is an example of a “second approximation expression”. In the present embodiment, the supply curve model 143 includes a supply slope model 143a and a supply intercept model 143b.

The supply slope model 143a is a machine learning model that receives the contract price in the second time slot which is time-series data as an input and outputs an estimated value of a slope of a supply approximation expression obtained by approximating the supply curve in the first time slot for each second time slot to a linear function. For example, the supply slope model 143a is a model using the RNN. For example, the supply slope model 143a may use the LSTM network, which is a type of the RNN.

The supply intercept model 143b is a machine learning model that receives the contract price in the second time slot which is time-series data as an input and outputs an estimated value of an intercept of a supply approximation expression obtained by approximating the supply curve in the first time slot for each second time slot to a linear function. For example, the supply intercept model 143b is a model using the RNN. For example, the supply intercept model 143b may use the LSTM network.

The contract price model 141 receives information on a slope and an intercept corresponding to the demand curve in the first time slot as an input, and outputs a contract price in the first time slot. For example, the contract price model 141 receives values of the slope and the intercept of the demand approximation expression estimated by the demand curve model 142 and values of the slope and the intercept of the supply approximation expression estimated by the supply curve model 143 as inputs, and outputs a contract price in the first time slot. When the contract price in the second time slot is input, the contract price model 141 is trained by using an output value obtained in a case where the values of the slope and the intercept estimated by the demand curve model 142 and the supply curve model 143 are used as inputs and the contract price in the first time slot.

In the training phase, the approximation unit 12 approximates a known demand curve and a known supply curve to obtain a demand approximation expression and a supply approximation expression serving as training data. The approximation unit 12 includes an initial function generation unit 121, a smoothing unit 122, and an intercept calculation unit 123. For example, the demand approximation expression is represented by Expression (1) below, and the supply approximation expression is represented by Expression (2) below.

$$y = {a}_{Buy} x + {b}_{Buy} \qquad ( 1 )$$

$$y = {a}_{Sell} x + {b}_{Sell} \qquad ( 2 )$$

a_{Buy} is a slope of the demand approximation expression, and b_{Buy} is an intercept of the demand approximation expression. a_{Sell} is a slope of the supply approximation expression, and b_{Sell} is an intercept of the supply approximation expression. For example, the demand approximation expression is defined by a_{Buy} and b_{Buy}, and the supply approximation expression is defined by a_{Sell} and b_{Sell}.

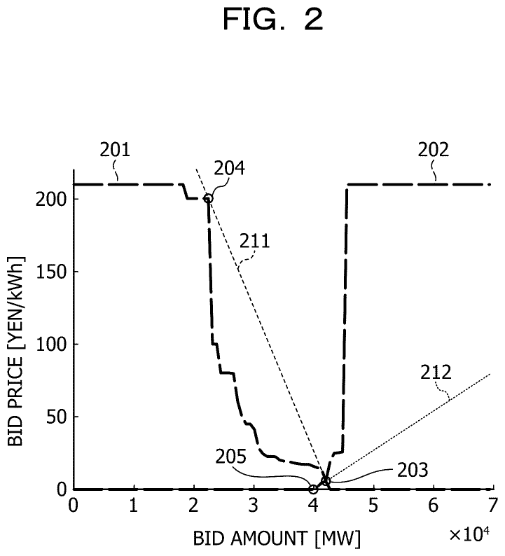

The initial function generation unit 121 generates an initial function which is a linear function which serves as a temporarily determined basis and is used to approximate the demand curve and the supply curve to the linear function to obtain the training data. FIG. 2 is a diagram for explaining the generation of the initial function. The initial function generation unit 121 acquires information on a demand curve 201 and a supply curve 202 in a first time slot illustrated in FIG. 2. Next, the initial function generation unit 121 specifies an intersection point 203 between the demand curve 201 and the supply curve 202.

Next, the initial function generation unit 121 extracts one appropriate point on the demand curve as an extraction point. In the present embodiment, the initial function generation unit 121 sets, as the extraction point, a bid price for a bid amount immediately before the bid price drops most rapidly. For example, the initial function generation unit 121 extracts a maximum change rate start point 204 which is a start point of a place where a decrease rate is the highest in the demand curve 201. Next, the initial function generation unit 121 creates a demand initial function 211 which is a linear function passing through the intersection point 203 and the maximum change rate start point 204.

Also for the supply curve, the initial function generation unit 121 extracts one appropriate point on the supply curve as an extraction point. In the present embodiment, the initial function generation unit 121 sets a bid price for a bid amount immediately before the bid price rises for the first time as the extraction point. For example, the initial function generation unit 121 extracts a rise start point 205 at which the bid price starts to rise from 0 on the supply curve 202. Next, the initial function generation unit 121 creates a supply initial function 212 which is a linear function passing through the intersection point 203 and the rise start point 205.

For each of a plurality of first time slots used for training, which are a plurality of different time slots serving as data, the initial function generation unit 121 similarly creates a demand initial function and a supply initial function. Thereafter, the initial function generation unit 121 outputs information on slopes and intercepts of the respective created demand initial functions and information on slopes and intercepts of the respective created supply initial functions to the smoothing unit 122. This demand initial function is an example of a “first function” and the supply initial function is an example of a “second function”.

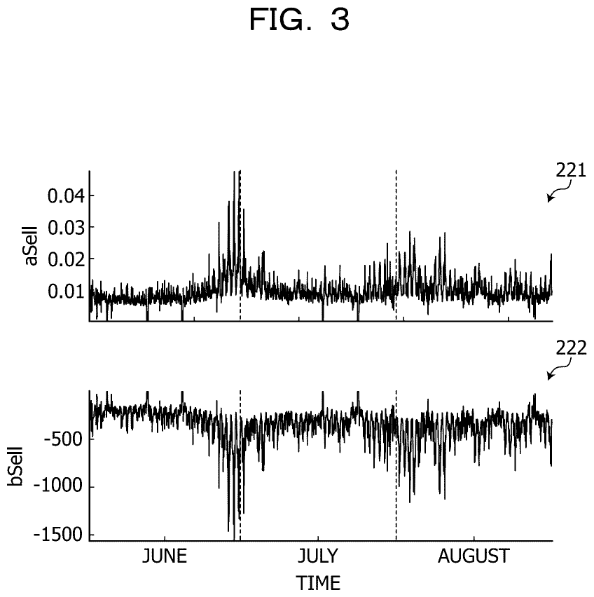

FIG. 3 is a diagram illustrating an example of time-series changes in values of the slope and the intercept of the demand initial function created by the initial function generation unit. A graph 221 in FIG. 3 represents a time-series change in the slope of the demand initial function, and a graph 222 represents a time-series change in the intercept of the demand initial function. The graph 221 indicates a measurement unit time slot over time by a horizontal axis and indicates a slope value by a vertical axis. The graph 222 indicates a measurement unit time slot over time by a horizontal axis and indicates an intercept value by a vertical axis.

As indicated in graphs 221 and 222, the slope and the intercept of the demand initial function frequently and greatly change along the time-series. For this reason, in a case where the demand curve model 142 is trained by using the data of the slope and the intercept indicated in the graphs 221 and 222, it is difficult to grasp the tendency, and there is a risk that estimation accuracy of the slope and the intercept may decrease. For this reason, it is not preferable to train the demand curve model 142 by using the demand initial function as it is. Accordingly, the following processing is performed in the approximation unit 12.

For each of the plurality of different first time slots, the smoothing unit 122 receives, from the initial function generation unit 121, an input of information on a slope and an intercept of the demand initial function 211 and information on a slope and an intercept of the supply initial function 212. The smoothing unit 122 smooths the slope value of the demand initial function 211 along the time-series such that the change is smoothed, for example, such that a frequency of large variations is suppressed. For example, the smoothing unit 122 performs smoothing by calculating a moving average of the slope values of the demand initial function 211 along the time-series. For example, the smoothing unit 122 smooths the slope by using an arithmetic average of values in seven consecutive measurement unit time slots along the time-series.

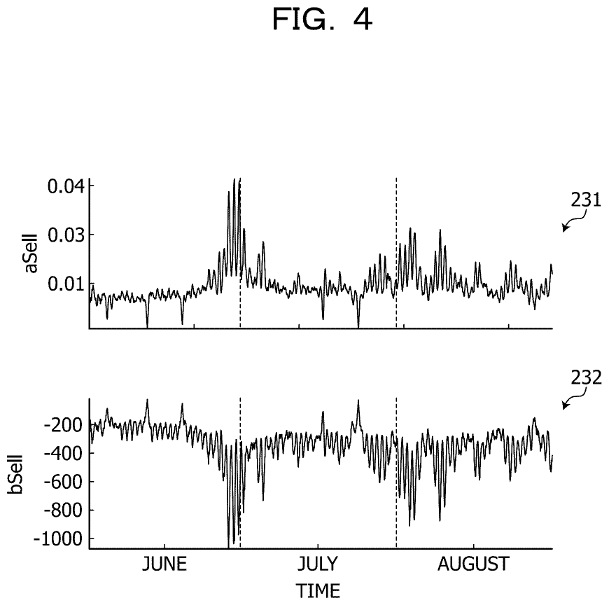

FIG. 4 is a diagram illustrating an example of time-series changes in the values of the slope and the intercept after smoothing. For example, the smoothing unit 122 smooths information on the slope indicated in the graph 221 in FIG. 3 by using the moving average to calculate a slope value whose change is smoothed as indicated in a graph 231 in FIG. 4. The graph 231 indicates a measurement unit time slot over time by a horizontal axis and indicates a slope value by a vertical axis. As indicated in the graph 231, the change of the slope value after smoothing is smoothed as the variation frequency is suppressed as compared with the graph 221.

Although the smoothing unit 122 uses the moving average as a noise removal filter for smoothing the change in the slope value along the time-series in the present embodiment, another noise removal filter may be used. For example, the smoothing unit 122 may perform smoothing by using an exponential smoothing filter or a Kalman filter.

As in the case of the demand initial function 211, the smoothing unit 122 smooths the slope value of the supply initial function 212 along the time-series such that the change is smoothed. Hereinafter, the slopes obtained by smoothing the slopes of the demand initial function and the supply initial function are referred to as “smoothed slopes”. Thereafter, the smoothing unit 122 outputs the smoothed slope values of the demand initial function and the supply initial function for each of the plurality of different first time slots to the intercept calculation unit 123.

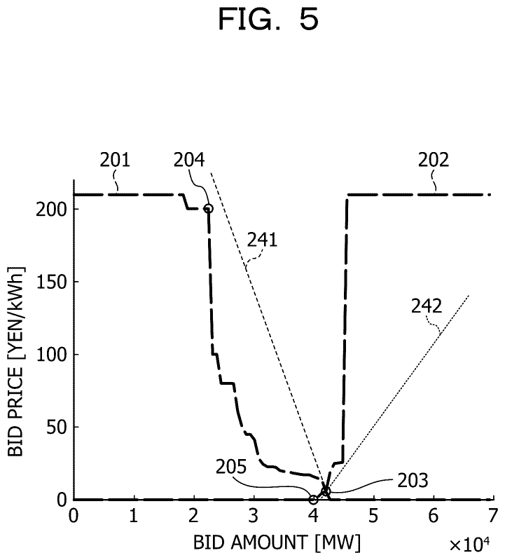

For each of the plurality of different first time slots, the intercept calculation unit 123 receives, from the smoothing unit 122, an input of the smoothed slope values of each of the demand initial function and the supply initial function. FIG. 5 is a diagram for explaining creation of a demand approximation expression and a supply approximation expression.

For each of the plurality of different first time slots, the intercept calculation unit 123 calculates a demand approximation expression 241 which is a linear function having the smoothed slope of the demand initial function and passing through the intersection point 203. In this case, since the slope is smoothed, most of the demand approximation expression 241 does not pass through the maximum change rate start point 204 as illustrated in FIG. 5. The intercept calculation unit 123 obtains an intercept of the calculated demand approximation expression 241.

Similarly, for each of the plurality of different first time slots, the intercept calculation unit 123 calculates a supply approximation expression 242 which is a linear function having the smoothed slope of the supply initial function and passing through the intersection point 203. Also in this case, since the slope is smoothed, most of the supply approximation expression 242 does not pass through the rise start point 205 as illustrated in FIG. 5. The intercept calculation unit 123 calculates an intercept of the calculated supply approximation expression 242.

For example, a temporal change of the intercept calculated by the intercept calculation unit 123 is a value as indicated in a graph 232 in FIG. 4. The graph 232 indicates a measurement unit time slot over time by a horizontal axis and indicates an intercept value by a vertical axis. As indicated in the graph 232, the change of the intercept value calculated by the intercept calculation unit 123 is smoothed as the variation frequency is suppressed as compared with the graph 222 in FIG. 3.

As described above, by smoothing the temporal changes of the slope and the intercept, in a case where the demand curve model 142 is trained by using these pieces of information, it is possible to perform appropriate training, and it is possible to improve estimation accuracy of the slope and the intercept. Although the change in the intercept value is smoothed by smoothing the change in the slope in the present embodiment in the present embodiment, the smoothing is not limited to this, and the smoothing unit 122 may simultaneously smooth the changes in the slope and the intercept of the demand curve.

For example, in a case where the change in the intercept value is smoothed by smoothing the change in the slope, the demand approximation expression 241 and the supply approximation expression 242 may be determined by the following processing. Without completely creating the demand initial function 211 and the supply initial function 212, the initial function generation unit 121 extracts slope values of the respective functions. Next, the smoothing unit 122 receives an input of the respective slope values extracted by the initial function generation unit 121 and smooths the respective slope values. The intercept calculation unit 123 calculates respective intercept values from the respective smoothed slopes. As described above, the demand approximation expression 241 and the supply approximation expression 242 may be determined.

As described above, the approximation unit 12 performs processing of approximating the demand curve and the supply curve to the demand approximation expression and the supply approximation expression in each of the plurality of different first time slots. Accordingly, the approximation unit 12 may create a plurality of pieces of data to be used for training of the demand curve model 142 and the supply curve model 143. As described above, the first time slot for which the demand approximation expression and the supply approximation expression used as the training data have been obtained is an example of a “first period”.

The description is continued by returning to FIG. 1. The model generation unit 13 includes a first model generation unit 131 and a second model generation unit 132. The model generation unit 13 trains the demand curve model 142 by using information on the slope and the intercept of the demand approximation expression in the plurality of first time slots obtained by the approximation unit 12 and information on a contract price in a second time slot corresponding to each first time slot. The model generation unit 13 trains the supply curve model 143 by using information on the slope and the intercept of the supply approximation expression in the plurality of first time slots obtained by the approximation unit 12 and information on a contract price in a second time slot corresponding to each first time slot. Details of the training will be described below.

For example, the model generation unit 13 generates the demand curve model 142 and the supply curve model 143, which are machine learning models, by respectively performing training by using data of the slopes and the intercepts of the demand approximation expression, which is the first approximation expression, and the supply approximation expression, which is the second approximation expression. For example, the model generation unit 13 respectively performs training by using data of a plurality of slopes and a plurality of intercepts that respectively correspond to a plurality of demand approximation expressions and a plurality of supply approximation expressions.

The first model generation unit 131 is in charge of training of the demand curve model 142. The first model generation unit 131 acquires information on a slope of a demand approximation expression for each of the plurality of different first time slots from the smoothing unit 122. The first model generation unit 131 acquires information on an intercept of the demand approximation expression for each of the plurality of different first time slots from the smoothing unit 122.

Next, the first model generation unit 131 acquires, from the data storage unit 11, a contract price in a second time slot corresponding to each first time slot for which the demand approximation expression has been obtained. The first model generation unit 131 acquires, for example, information on a temperature, a day of week, and a power use rate in each first time slot from the data storage unit 11.

For example, the first model generation unit 131 trains the demand curve model 142 by using, as training data, the contract price in the second time slot, the information on the temperature, the day of week, and the power use rate in the first time slot, and the slope and the intercept of the demand approximation expression for each corresponding first time slot. For example, the first model generation unit 131 inputs the contract price in the second time slot and the information on the temperature, the day of week, and the power use rate in the first time slot to the demand slope model 142a. Based on an error between the output from the demand slope model 142a and the slope of the demand approximation expression for each corresponding first time slot, the first model generation unit 131 adjusts parameters of the demand slope model 142a. For example, the first model generation unit 131 inputs the contract price in the second time slot and the information on the temperature, the day of week, and the power use rate in the first time slot to the demand intercept model 142b. Based on an error between the output from the demand intercept model 142b and the intercept of the demand approximation expression for each corresponding first time slot, the first model generation unit 131 adjusts parameters of the demand intercept model 142b.

The second model generation unit 132 is in charge of training of the supply curve model 143. The second model generation unit 132 acquires information on a slope of a supply approximation expression for each of the plurality of different first time slots from the smoothing unit 122. The second model generation unit 132 acquires information on an intercept of the supply approximation expression for each of the plurality of different first time slots from the smoothing unit 122.

Next, the second model generation unit 132 acquires, from the data storage unit 11, a contract price in a second time slot corresponding to each first time slot for which the supply approximation expression has been obtained. The second model generation unit 132 acquires, for example, information on a temperature, a day of week, and a power use rate in each first time slot from the data storage unit 11.

For example, the second model generation unit 132 trains the supply curve model 143 by using, as training data, the contract price in the second time slot, the information on the temperature, the day of week, and the power use rate in the first time slot, and the slope and the intercept of the supply approximation expression for each corresponding first time slot. For example, the second model generation unit 132 inputs the contract price in the second time slot and the information on the temperature, the day of week, and the power use rate in the first time slot to the supply slope model 143a. Based on an error between the output from the supply slope model 143a and the slope of the supply approximation expression for each corresponding first time slot, the second model generation unit 132 adjusts parameters of the supply slope model 143a. For example, the second model generation unit 132 inputs the contract price in the second time slot and the information on the temperature, the day of week, and the power use rate in the first time slot to the supply intercept model 143b. Based on an error between the output from the supply intercept model 143b and the intercept of the supply approximation expression for each corresponding first time slot, the second model generation unit 132 adjusts parameters of the supply intercept model 143b.

A demand amount of power is influenced by, for example, a temperature, a day of week, and a power use rate. Accordingly, as described above, the first model generation unit 131 reflects the information such as the temperature and the day of week also in the estimation of the slope and the intercept of the demand approximation expression. Since a supply amount of power changes in accordance with the demand amount, the supply amount is also influenced by, for example, the temperature, the day of week, or the power use rate. Accordingly, as described above, the second model generation unit 132 reflects the information such as the temperature and the day of week also in the estimation of the slope and the intercept of the supply approximation expression. Accordingly, the first model generation unit 131 and the second model generation unit 132 may predict the demand approximation expression and the supply approximation expression with high accuracy in consideration of the influence of the temperature, the day of week, the power use rate, or the like.

When a contract amount approaches a total selling bid amount, a contract price rapidly rises. Accordingly, the first model generation unit 131 and the second model generation unit 132 may reflect information on a difference between the total selling bid amount and the contract amount in the determination of one or both of the slope and the intercept. For example, the first model generation unit 131 causes the demand slope model 142a and the demand intercept model 142b to estimate a slope and an intercept of the demand approximation expression by using, as an input, training data including a smallest value of the difference between the total selling bid amount and the contract amount among time slots that are other transaction targets on the same day as the first time slot. Accordingly, the first model generation unit 131 obtains a slope and an intercept of the demand approximation expression in consideration of the difference between the total selling bid amount and the contract amount, and by training the demand slope model 142a and the demand intercept model 142b by using the slope and the intercept, it is possible to perform training with further improved estimation accuracy. By predicting the contract price using the slope and the intercept of the demand approximation expression obtained from the demand slope model 142a and the demand intercept model 142b trained as described above, a contract price with high accuracy may be obtained. The same applies to the second model generation unit 132.

In the present embodiment, the model generation unit 13 trains both the demand curve model 142 and the supply curve model 143 by using the demand approximation expression and the supply approximation expression in which a demand curve and a supply curve are approximated to linear functions. However, for example, in a case where the demand curve is approximated by a sigmoid function, an approximation function has a large amount of temporal change, and it is difficult to use the approximation function for estimation of the contract price. By contrast, in a case where the supply curve is approximated by a sigmoid function, since an approximation function does not have a large amount of temporal change, it is possible to use the approximation function to estimate the contract price. Accordingly, the model generation unit 13 may train the demand curve model 142 to estimate a demand approximation expression obtained by approximating a demand curve to a linear function, and may train the supply curve model 143 to estimate a supply curve approximated by a sigmoid function.

By using the trained contract price model 141, the trained demand curve model 142, and the trained supply curve model 143, the estimation unit 15 estimates a contract price in a first time slot based on an input contract price in a second time slot. Hereinafter, details of the estimation unit 15 will be described.

As illustrated in FIG. 1, the estimation unit 15 includes a demand curve estimation unit 151, a supply curve estimation unit 152, and a contract price estimation unit 153. Hereinafter, a first time slot serving as an estimation target is referred to as an “estimation target time slot”, and a second time slot relative to the estimation target time slot, for example, a second time slot from which a contract price to be used for the estimation is acquired is referred to as an “estimation source time slot”. The estimation target time slot is a time slot in future relative to an estimation time, and the estimation source time slot is a time slot in past relative to the estimation time. A user acquires a contract price in an estimation source time slot already confirmed in a spot market. By using a user terminal 2, the user inputs the contract price in the estimation source time slot, which is already confirmed in the spot market, to the contract price estimation device 1, and requests the contract price estimation device 1 to estimate a contract price in the estimation target time slot.

From the user terminal 2, the demand curve estimation unit 151 receives the input of the contract price in the estimation source time slot already confirmed in the spot market. Next, the demand curve estimation unit 151 inputs the contract price in the estimation source time slot to the trained demand slope model 142a. The demand curve estimation unit 151 acquires an estimation result of a slope of a demand approximation expression in the estimation target time slot output from the demand slope model 142a. The demand curve estimation unit 151 inputs the contract price in the estimation source time slot to the trained demand intercept model 142b. The demand curve estimation unit 151 acquires an estimation result of an intercept of the demand approximation expression in the estimation target time slot output from the demand intercept model 142b. Thereafter, the demand curve estimation unit 151 outputs information on the slope and the intercept of the demand approximation expression in the estimation target time slot to the contract price estimation unit 153 as information indicating an estimated demand curve in the estimation target time slot.

From the user terminal 2, the supply curve estimation unit 152 receives the input of the contract price in the estimation source time slot already confirmed in the spot market. Next, the supply curve estimation unit 152 inputs the contract price in the estimation source time slot to the trained supply slope model 143a. The supply curve estimation unit 152 acquires an estimation result of a slope of a supply approximation expression in the estimation target time slot output from the supply slope model 143a. The supply curve estimation unit 152 inputs the contract price in the estimation source time slot to the trained supply intercept model 143b. The supply curve estimation unit 152 acquires an estimation result of an intercept of the supply approximation expression in the estimation target time slot output from the supply intercept model 143b. Thereafter, the supply curve estimation unit 152 outputs information on the slope and the intercept of the supply approximation expression in the estimation target time slot to the contract price estimation unit 153 as information indicating an estimated demand curve in the estimation target time slot.

Because the features of the demand curve and supply curve appear in the slopes and the intercepts of the demand approximation expression and the supply approximation expression, the contract price estimation unit 153 predicts the contract price by using the slopes and the intercepts as explanatory variables of the contract price model 141. Hereinafter, the operation of the contract price estimation unit 153 will be described.

During the training phase, the contract price estimation unit 153 may perform training of the contract price model 141. For example, the contract price estimation unit 153 acquires information on a slope and an intercept of each of a demand approximation expression and a supply approximation expression in a plurality of first time slots estimated by the demand curve model 142 and the supply curve model 143 from the past data. The contract price estimation unit 153 acquires an actual contract price for each first time slot for which the slope and the intercept of the demand approximation expression and the supply approximation expression have been obtained. The contract price estimation unit 153 may train the contract price model 141 by using, as training data, the slope and the intercept of each of the demand approximation expression and the supply approximation expression in the first time slot and the actual contract price in the first time slot. However, the contract price estimation unit 153 may use the contract price model 141 trained by a unit other than the contract price estimation unit 153.

In an estimation phase, the contract price estimation unit 153 receives, from the demand curve estimation unit 151 and the supply curve estimation unit 152, the input of information on the slope and the intercept of each of the demand approximation expression and the supply approximation expression estimated in the estimation target time slot. Next, the contract price estimation unit 153 inputs the information on the slope and the intercept of each of the demand approximation expression and the supply approximation expression estimated in the estimation target time slot to the contract price model 141. The contract price estimation unit 153 acquires an estimation result of a contract price in the estimation target time slot output from the contract price model 141. Thereafter, the contract price estimation unit 153 transmits the estimation result of the contract price in the estimation target time slot through the estimation result in response to a request from the user to the user terminal 2 and provides the estimation result to the user.

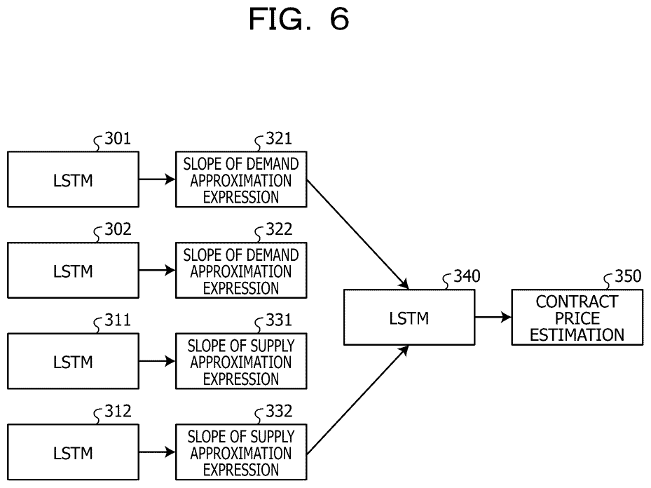

FIG. 6 is a diagram illustrating an outline of estimation processing performed by the estimation unit. LSTMs 301, 302, 311, and 312 in FIG. 6 are specific examples of the demand slope model 142a, the demand intercept model 142b, the supply slope model 143a, and the supply intercept model 143b, respectively. An LSTM 340 is a specific example of the contract price model 141. The estimation processing in the estimation phase will be collectively described with reference to FIG. 6.

The demand curve estimation unit 151 inputs the confirmed contract price in the estimation source time slot to the LSTM 301 corresponding to the demand slope model 142a, and obtains an output slope 321 of the demand approximation expression that is output. The demand curve estimation unit 151 inputs the confirmed contract price in the estimation source time slot to the LSTM 302 corresponding to the demand intercept model 142b, and obtains an output intercept 322 of the demand approximation expression.

The supply curve estimation unit 152 inputs the confirmed contract price in the estimation source time slot to the LSTM 311 corresponding to the supply slope model 143a, and obtains an output slope 331 of the supply approximation expression. The supply curve estimation unit 152 inputs the confirmed contract price in the estimation source time slot to the LSTM 312 corresponding to the supply intercept model 143b, and obtains an output intercept 332 of the supply approximation expression.

The contract price estimation unit 153 inputs the slope 321 of the demand approximation expression, the intercept 322 of the demand approximation expression, the slope 331 of the supply approximation expression, and the intercept 332 of the supply approximation expression to the LSTM 340 corresponding to the contract price model 141, and obtains a output contract price estimated value 350 in the estimation target time slot. As described above, the estimation unit 15 may estimate the contract price in the estimation target time slot.

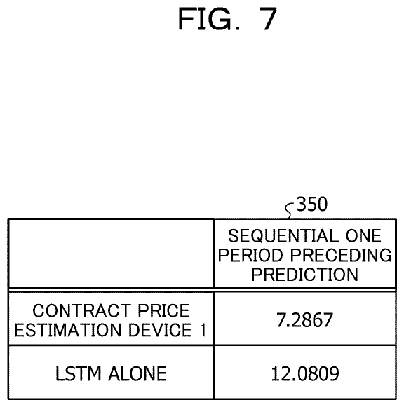

FIG. 7 is a diagram illustrating a comparison of prediction errors between estimation by the contract price estimation device according to the first embodiment and the estimation using the LSTM alone. The estimation using the LSTM alone is estimation using the LSTM that has been trained to estimate the contract price without using a demand curve or a supply curve. A measurement unit is 30 minutes. Table 350 indicates a result of a prediction error in a sequential one period preceding prediction in which the second time slot serving as the estimation source time slot is set as the measurement unit immediately before the first time slot serving as the estimation target time slot.

As indicated in Table 350, in the case of the estimation by the contract price estimation device 1 according to the present embodiment, the prediction error is 7.2867. By contrast, in the case of the estimation using the LSTM alone, the prediction error is 12.0809. For example, it may be said that the features of the demand curve and the supply curve accurately appear in the slopes and the intercepts of the estimated demand approximation expression and the supply approximation expression, and the contract price estimation device 1 may make the prediction error small by predicting a contract price using the slopes and the intercepts as explanatory variables.

As described above, the estimation unit 15 estimates an intersection point between the demand curve and the supply curve in a second period that corresponds to a period after a first period used for training, by using the trained machine learning model. A value represented by the intersection point of the demand curve and the supply curve corresponds to a contract price. For example, the estimation unit 15 estimates an intercept and a slope of each of a first approximation expression and a second approximation expression in the second time slot by using the machine learning model. The estimation unit 15 executes processing of estimating an intersection point between a first curve and a second curve including processing of estimating the intersection point between the first curve and the second curve based on the estimated intercepts and slopes.

Although the demand curve model 142, the supply curve model 143, and the contract price model 141 are separately trained in the present embodiment, these models may be collectively trained. For example, for a given contract price, an estimated contract price obtained by using the demand curve model 142, the supply curve model 143, and the contract price model 141 may be acquired, and the parameters of the demand curve model 142, the supply curve model 143, and the contract price model 141 may be adjusted based on an error between the acquired contract price and the estimation result.

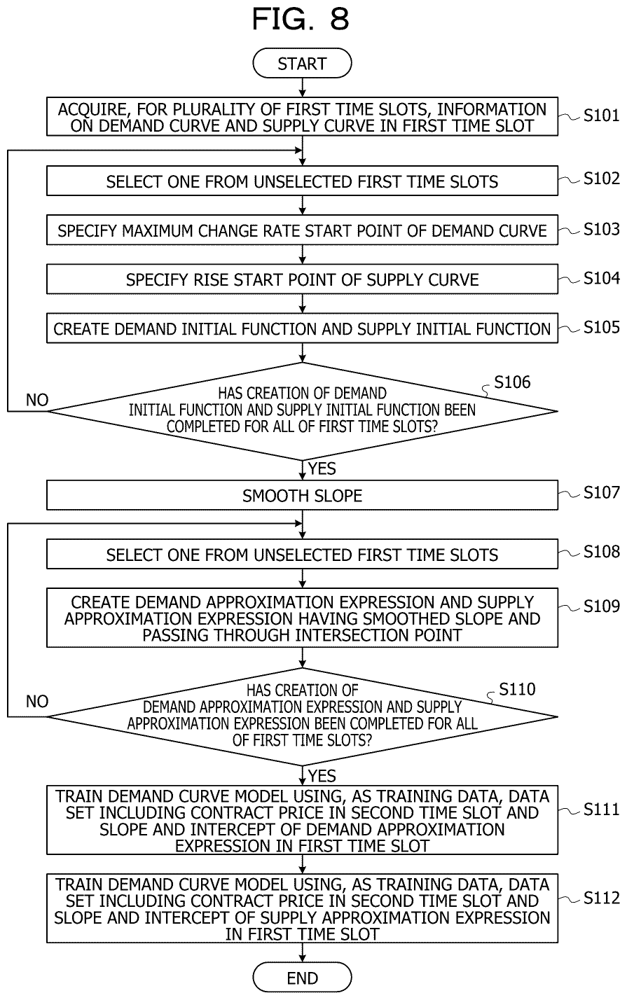

FIG. 8 is a flowchart of training processing of the demand curve model and the supply curve model in the training phase. A flow of the training processing of the demand curve model 142 and the supply curve model 143 in the training phase of the contract price estimation device 1 according to the present embodiment will be described next with reference to FIG. 8.

For a plurality of first time slots in the past, the initial function generation unit 121 acquires, from the data storage unit 11, information on a demand curve and a supply curve in an already confirmed first time slot made public in the spot market (step S101).

Next, the initial function generation unit 121 selects one first time slot from among unselected first time slots in the plurality of first time slots for which the demand curve and the supply curve have been acquired (step S102).

Next, the initial function generation unit 121 specifies a maximum change rate start point of the demand curve in the selected first time slot (step S103).

Next, the initial function generation unit 121 specifies a rise start point of the supply curve in the selected first time slot (step S104).

Next, the initial function generation unit 121 creates a demand initial function which is a linear function that couples an intersection point of the demand curve and the supply curve and the maximum change rate start point. The initial function generation unit 121 creates a supply initial function which is a linear function that couples the intersection point of the demand curve and the supply curve and the rise start point (step S105).

Next, the initial function generation unit 121 determines whether the creation of the demand initial function and the supply initial function has been completed for all the plurality of first time slots for which the demand curve and the supply curve have been acquired (step S106). When a first time slot for which the demand initial function and the supply initial function have not been created remains (step S106: No), the initial function generation unit 121 returns to step S102.

By contrast, when the creation of the demand initial function and the supply initial function for all the plurality of first time slots has been completed (step S106: Yes), the initial function generation unit 121 outputs the demand initial function and the supply initial function for each of the plurality of first time slots to the smoothing unit 122. The smoothing unit 122 acquires changes over time in the slopes of the demand initial function and the supply initial function created by the initial function generation unit 121. By using a moving average for the changes in the slopes over time, the smoothing unit 122 performs smoothing of the slopes for each of the demand initial function and the supply initial function for each first time slot (step S107).

The intercept calculation unit 123 acquires the smoothed slopes of the demand initial function and the supply initial function for each first time slot from the smoothing unit 122. Next, the intercept calculation unit 123 selects one first time slot from among unselected first time slots in the plurality of first time slots for which the demand initial function and the supply initial function have been obtained (step S108).

Next, for the selected first time slot, the intercept calculation unit 123 creates a demand approximation expression which is a linear function having a smoothed slope of the demand initial function and passing through the intersection point between the demand curve and the supply curve. For the selected first time slot, the intercept calculation unit 123 creates a supply approximation expression which is a linear function having a smoothed slope of the supply initial function and passing through the intersection point of the demand curve and the supply curve (step S109).

Next, the intercept calculation unit 123 determines whether the creation of the demand approximation expression and the supply approximation expression has been completed for all the plurality of first time slots for which the demand initial function and the supply initial function have been obtained (step S110). When a first time slot for which the demand approximation expression and the supply approximation expression have not been created remains (step S110: No), the initial function generation unit 121 returns to step S108.

By contrast, when the creation of the demand approximation expression and the supply approximation expression has been completed for all the plurality of first time slots (step S110: Yes), the intercept calculation unit 123 specifies intercepts of the demand approximation expression and the supply approximation expression for each of the first time slots. The first model generation unit 131 and the second model generation unit 132 acquire, from the smoothing unit 122, the smoothed slopes of the demand initial function and the supply initial function for each first time slot. The first model generation unit 131 and the second model generation unit 132 acquire the intercept of each of the demand approximation expression and the supply approximation expression for each first time slot from the intercept calculation unit 123. The first model generation unit 131 and the second model generation unit 132 acquire, from the data storage unit 11, a contract price already confirmed in the spot market for a second time slot corresponding to the first time slot for which the demand approximation expression and the supply approximation expression have been estimated. In the present embodiment, the first model generation unit 131 and the second model generation unit 132 acquire information on a temperature, a day of week, and a power use rate in the first time slot from the data storage unit 11.

The first model generation unit 131 trains the demand curve model 142 by using, as training data, a data set including the contract price in the second time slot and the slope and the intercept of the demand approximation expression in the first time slot (step S111). In the present embodiment, the first model generation unit 131 includes the temperature, the day of week, and the power use rate in each first time slot in the data set serving as the training data. For example, the first model generation unit 131 trains each of the demand slope model 142a and the demand intercept model 142b.

The second model generation unit 132 trains the supply curve model 143 by using, as training data, a data set including the contract price in the second time slot and the slope and the intercept of the supply approximation expression in the first time slot (step S112). In the present embodiment, the second model generation unit 132 also includes, for example, the temperature, the day of week, and the power use rate in each first time slot in the data set serving as the training data. For example, the second model generation unit 132 trains each of the supply slope model 143a and the supply intercept model 143b. As described above, the training of the demand curve model 142 and the supply curve model 143 in the training phase is completed.

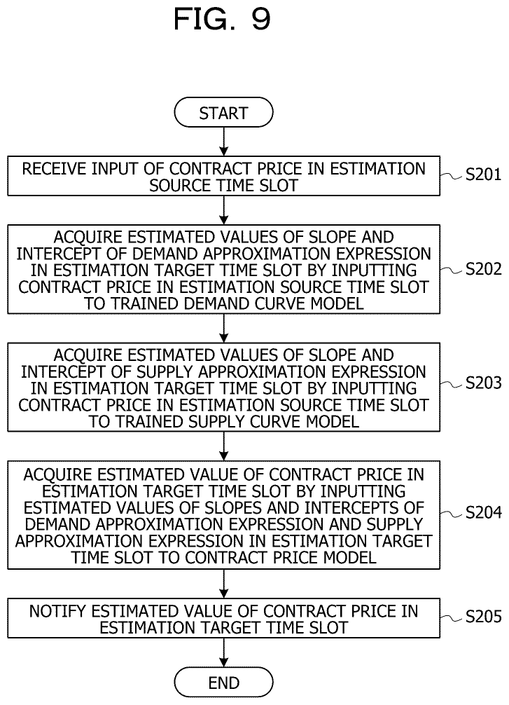

FIG. 9 is a flowchart of estimation processing by the contract price estimation device in the estimation phase. Next, a flow of contract price estimation processing in the estimation phase of the contract price estimation device 1 according to the present embodiment will be described with reference to FIG. 9.

The demand curve estimation unit 151 and the supply curve estimation unit 152 receive, from the user terminal 2, an input of the contract price in the second time slot which is an estimation source time slot together with an estimation request for the contract price in an estimation target time slot (step S201).

Next, the demand curve estimation unit 151 inputs the contract price in the estimation source time slot to the demand slope model 142a and the demand intercept model 142b, which are the trained demand curve model 142. The demand curve estimation unit 151 acquires an estimated value of a slope of a demand approximation expression in a first time slot which is the estimation target time slot from the demand slope model 142a. The demand curve estimation unit 151 acquires an estimated value of an intercept of the demand approximation expression in the estimation target time slot from the demand intercept model 142b (step S202).

The supply curve estimation unit 152 inputs the contract price in the estimation source time slot to the supply slope model 143a and the supply intercept model 143b which are the trained supply curve model 143. The supply curve estimation unit 152 acquires an estimated value of a slope of a supply approximation expression in the estimation target time slot from the supply slope model 143a. The supply curve estimation unit 152 acquires an estimated value of an intercept of the supply approximation expression in the estimation target time slot from the supply intercept model 143b (step S203).

The contract price estimation unit 153 inputs the estimated values of the slope and the intercept of each of the demand approximation expression and the supply approximation expression in the estimation target time slot to the contract price model 141. The contract price estimation unit 153 acquires the estimated value of the contract price in the estimation target time slot output from the contract price model 141 (step S204).

Thereafter, the contract price estimation unit 153 transmits, to the user terminal 2, the estimated value of the contract price in the estimation target time slot as an estimation result for the request from the user, and provides the estimated value to the user (step S205).

### (Hardware Configuration)

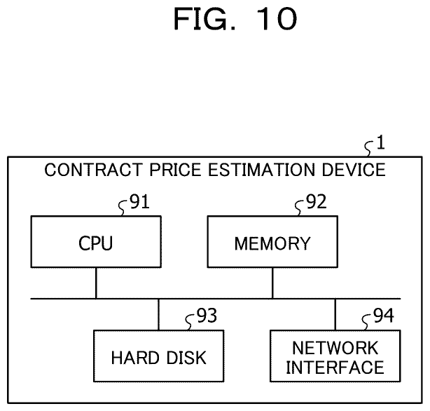

FIG. 10 is a diagram illustrating a hardware configuration of the contract price estimation device according to the first embodiment. An example of a hardware configuration for implementing each function of the contract price estimation device 1 will be described next with reference to FIG. 10.

As illustrated in FIG. 10, the contract price estimation device 1 includes, for example, a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the contract price estimation device 1 and an external device. For example, the network interface 94 relays communication between the user terminal 2 and the CPU 91.

The hard disk 93 is an auxiliary storage device. The hard disk 93 implements the functions of the data storage unit 11 and the model storage unit 14 illustrated in FIG. 1. The hard disk 93 stores various programs including a program for implementing the functions of the approximation unit 12, the model generation unit 13, and the estimation unit 15 illustrated in FIG. 1.

The memory 92 is a main storage device. For example, a dynamic random-access memory (DRAM) may be used as the memory 92.

The CPU 91 reads the various programs from the hard disk 93, develops the programs into the memory 92, and executes the programs. Accordingly, the CPU 91 implements the functions of the approximation unit 12, the model generation unit 13, and the estimation unit 15 illustrated in FIG. 1.

As described above, the contract price estimation device according to the present embodiment approximates a demand curve and a supply curve in a first time slot to linear functions, and further, smooths a slope and an intercept along the time-series to create a demand approximation expression and a supply approximation expression. By using, as training data, a data set including the slopes and the intercepts of the created demand approximation expression and supply approximation expression and a contract price in a second time slot, the contract price estimation device trains a demand curve model and a supply curve model. As described above, by smoothing variations along the time-series of the demand approximation expression and the supply approximation expression, it is possible to appropriately learn parameters of the demand curve model and the supply curve model. By appropriately learning the parameters, it is possible to generate the demand curve model and the supply curve model that may accurately estimate the demand approximation expression and the supply approximation expression. The above-described method is not limited to the demand curve and the supply curve, and may be adopted for a curve of another form as long as it is a similar curve, and it is possible to determine a curve model and an intersection point with high accuracy.

The contract price estimation device estimates a contract price in an estimation target time slot by using the trained demand curve model and supply curve model, and a contract price model that estimates the contract price from estimated values of the slope and the intercept. For example, by improving estimation accuracy of the demand approximation expression and the supply approximation expression by the demand curve model and the supply curve model, it is possible to improve prediction accuracy of the contract price, and it is possible to predict a spot price with high accuracy by using demand-supply curve data.

### Second Embodiment

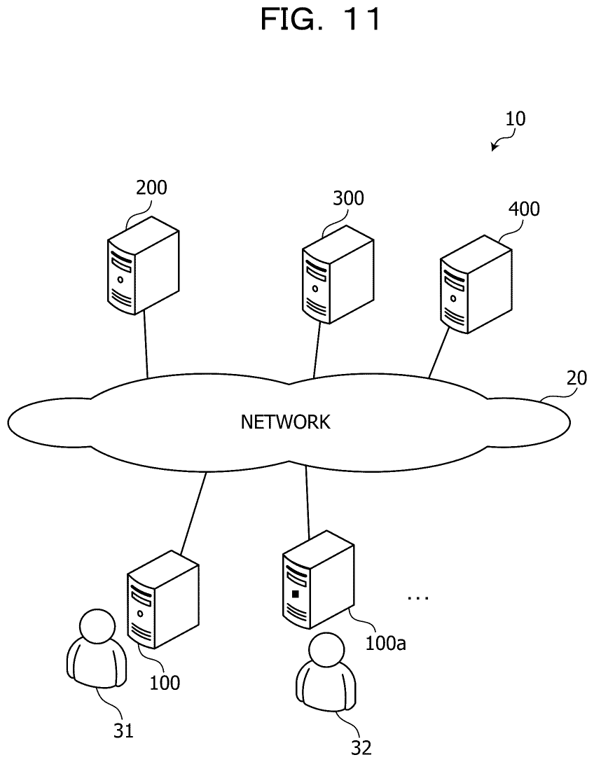

FIG. 11 is a diagram illustrating an example of a configuration of a computer system according to a second embodiment. A computer system 10 according to the second embodiment is a computer system that generates a model for estimating a demand curve and a supply curve in a spot market related to a power transaction with high accuracy and predicts a contract price by using the model.

In the computer system 10, a plurality of bidding computers 100, 100a, . . . , a transaction system 200, a power information server 300, and a weather information server 400 are coupled to a network 20.

For example, the plurality of bidding computers 100 and the 100a are computers used for bidding by a power generation business operator 31 or a power retail business operator 32. For example, the power generation business operator 31 uses the bidding computer 100, and the retail business operator 32 uses the bidding computer 100a.

The transaction system 200 is a computer that determines a contract price for each transfer time slot which is a time slot having a length of a measurement unit, and contracts a selling order and a buying order that are bid in each transfer time slot. For example, the transaction system 200 acquires a selling order of power from the bidding computer 100 used by the power generation business operator 31 and acquires a buying order of power from the bidding computer 100a used by the retail business operator 32. The transaction system 200 obtains a supply curve and a demand curve based on the selling order and the buying order, and sets an intersection point of these curves as a contract amount and a contract price.

The power information server 300 is a computer that provides data related to a use status of power. For example, the power information server 300 provides power information indicating a use rate of power for each date in response to requests from the bidding computers 100 and 100a.

The weather information server 400 is a computer that provides data related to weather information. For example, the weather information server 400 provides weather data indicating a temperature for each date in response to requests from the bidding computers 100 and 100a.

By such a computer system 10, a spot transaction of power is performed. For example, in a case of a day-ahead market, a previous day of the day (transfer day) on which the buying and selling of power is performed is a transaction day, a contract price is determined on the transaction day, and the transaction is established.

In the spot transaction of power, if a contract price in each transfer time slot of a transfer day may be accurately estimated before the transaction day, the power generation business operator 31 may sell generated power at a high price by placing a selling order in a transfer time slot having a high contract price. If the contract price in each transfer time slot of the transfer day may be accurately estimated before the transaction day, the retail business operator 32 may buy power at a low price by placing a buying order in the transfer time slot with a low contract price. Accordingly, the bidding computers 100 and 100a predict the contract price by using the function of the contract price estimation device 1.

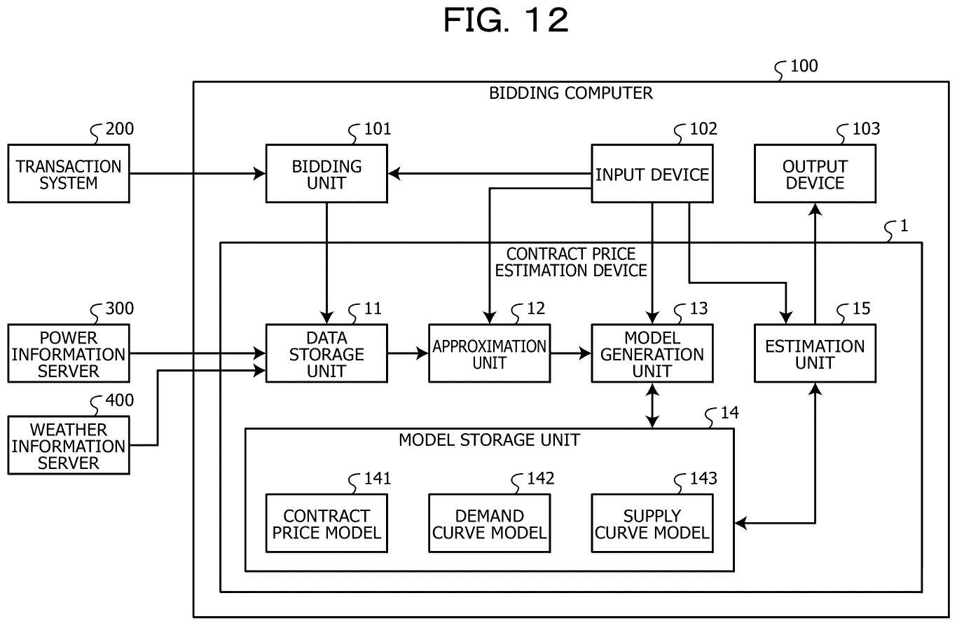

Estimation of the contract price will be described by using the bidding computer 100 as an example. FIG. 12 is a block diagram of the bidding computer. The bidding computer 100 has functions of the contract price estimation device 1 illustrated in FIG. 1. For example, the bidding computer 100 includes the data storage unit 11, the approximation unit 12, the model generation unit 13, the model storage unit 14, and the estimation unit 15 illustrated in FIG. 1. Although detailed functions of respective units are omitted in FIG. 12, the respective units actually have the same functions as those illustrated in FIG. 1. The bidding computer 100 includes a bidding unit 101, an input device 102, and an output device 103.

The input device 102 is a keyboard, a mouse, or the like. The output device 103 is a monitor or the like.

Upon receiving an instruction from the user via the input device 102, the bidding unit 101 transmits information on a selling bid or a buying bid to the transaction system 200 and makes a bid for a power trading market. The bidding unit 101 acquires transaction data related to a contracted transaction from the transaction system 200, and stores the transaction data in the data storage unit 11.

The data storage unit 11 stores transaction data, power data, and weather data. The transaction data is data related to a confirmed transaction in each transfer time slot. The power data is information such as a power use rate. The weather data is data related to weather such as a temperature.

The data storage unit 11 acquires power data related to a use rate of power or the like from the power information server 300 and stores the power data. The data storage unit 11 acquires weather data including information such as a temperature from the weather information server 400 and stores the weather data.

The initial function generation unit 121 of the approximation unit 12 acquires, from the data storage unit 11, a demand curve and a supply curve for each of a plurality of transfer time slots for which a transaction is already contracted. The initial function generation unit 121 of the approximation unit 12 generates a demand initial function and a supply initial function from the demand curve and the supply curve. The smoothing unit 122 of the approximation unit 12 smooths changes in slopes of the demand initial function and the supply initial function over time by moving average or the like. The intercept calculation unit 123 of the approximation unit 12 calculates a smoothed intercept by using the smoothed slope. As described above, the approximation unit 12 creates a demand approximation expression and a supply approximation expression.

The first model generation unit 131 and the second model generation unit 132 of the model generation unit 13 acquire a contract price, a temperature, a day of week, and a power use rate in a first time slot and a second time slot from the data storage unit 11. The first model generation unit 131 and the second model generation unit 132 of the model generation unit 13 generate a data set including these and use the data set as training data.

Next, the first model generation unit 131 of the model generation unit 13 trains the demand slope model 142a and the demand intercept model 142b included in the demand curve model 142 by using the training data. The second model generation unit 132 of the model generation unit 13 trains the supply slope model 143a and the supply intercept model 143b included in the supply curve model 143 by using the training data.

The demand curve estimation unit 151 of the estimation unit 15 acquires a contract price, a temperature, a day of week, and a power use rate in an estimation source time slot input by using the input device 102. The demand curve estimation unit 151 of the estimation unit 15 inputs the contract price, the temperature, the day of week, and the power use rate in the estimation source time slot to the trained demand curve model 142 and the trained supply curve model 143. The demand curve estimation unit 151 of the estimation unit 15 acquires estimated values of a slope and an intercept of each of the demand approximation expression and the supply approximation expression in the estimation source time slot. Next, the demand curve estimation unit 151 of the estimation unit 15 inputs the estimated values of the slope and the intercept of each of the demand approximation expression and the supply approximation expression in the estimation source time slot to the supply curve model 143, and acquires an estimated value of a contract price in an estimation target time slot. Thereafter, the estimation unit 15 transmits an estimation result of the contract price in the estimation target time slot to the output device 103 to cause the output device 103 to output the estimation result. Based on the estimated value of the contract price in the estimation target time slot output to the output device 103, the user may make a bid using the bidding unit 101.

For example, the estimation unit 15 estimates the contract price for a first time slot that is the estimation target time slot and is one day after a second time slot which is the estimation source time slot. Accordingly, the user may acquire an estimated value of the contract price one day before, and may make an appropriate bid in the time slot one day after.

As described above, by using the contract price, the temperature, the day of week, and the power use rate, the bidding computer in the computer system according to the present embodiment obtains the demand approximation expression and the supply approximation expression obtained by approximating the demand curve and the supply curve to linear functions. By using the demand approximation expression and the supply approximation expression, the bidding computer trains the demand curve model and the supply curve model. Thereafter, the bidding computer estimates the contract price by using the trained demand curve model, the trained supply curve model, and the contract price model. Accordingly, the estimation accuracy of the demand approximation expression and the supply approximation expression may be improved, and the contract price may be predicted with high accuracy.

Although the computer system 10 of the second embodiment predicts the contract price in a power transaction market, the embodiment is not limited to this. For example, also for transactions in markets other than those for power, by obtaining approximation expressions of linear functions of a demand curve and a supply curve and training a demand curve model and a supply curve model, it is possible to predict a contract price with high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an estimation program for causing a computer to execute a process comprising:
approximating a first curve and a second curve that has one intersection point with the first curve in a first period to a first approximation expression and a second approximation expression that are linear functions that pass through the intersection point, respectively;
generating a machine learning model by respectively performing training by using data of slopes and intercepts of the first approximation expression and the second approximation expression; and
estimating an intersection point between the first curve and the second curve in a second period that corresponds to a period after the first period by using the trained machine learning model.

2. The non-transitory computer-readable recording medium according to claim 1, wherein
the approximating includes approximating the first curve and the second curve to the first approximation expression and the second approximation expression in each of a plurality of the different first periods, and
the generating the machine learning model includes respectively performing training by using data of a plurality of slopes and a plurality of intercepts that respectively correspond to a plurality of the first approximation expressions and a plurality of the second approximation expressions.

3. The non-transitory computer-readable recording medium according to claim 1, wherein
the approximating includes
creating a first function that couples a point on the first curve and the intersection point,
creating a second function that couples a point on the second curve and the intersection point,
smoothing variations of each of slopes of the first function and the second function,
setting a function that has the smoothed slope of the first function and passes through the intersection point as the first approximation expression, and
setting a function that has the smoothed slope of the second function and passes through the intersection point as the second approximation expression.

4. The non-transitory computer-readable recording medium according to claim 1, wherein
the estimating the intersection point between the first curve and the second curve includes
estimating intercepts and slopes of the first approximation expression and the second approximation expression in the second period by using the machine learning model, and
estimating the intersection point between the first curve and the second curve based on the estimated intercepts and slopes.

5. The non-transitory computer-readable recording medium according to claim 1, wherein
the first curve is a demand curve, and
the second curve is a supply curve.

6. The non-transitory computer-readable recording medium according to claim 1, wherein
the first period and the second period are periods of every 30 minutes, and
the second period is a period one day after the first period.

7. An estimation method for causing a computer to execute a process comprising:
approximating a first curve and a second curve that has one intersection point with the first curve in a first period to a first approximation expression and a second approximation expression that are linear functions that pass through the intersection point, respectively;
generating a machine learning model by respectively performing training by using data of slopes and intercepts of the first approximation expression and the second approximation expression; and
estimating an intersection point between the first curve and the second curve in a second period that corresponds to a period after the first period by using the trained machine learning model.

8. An information processing apparatus comprising:
a memory; and
a processor coupled to the memory and configured to:
approximate a first curve and a second curve that has one intersection point with the first curve in a first period to a first approximation expression and a second approximation expression that are linear functions that pass through the intersection point, respectively;
generate a machine learning model by respectively performing training by using data of slopes and intercepts of the first approximation expression and the second approximation expression; and
estimate an intersection point between the first curve and the second curve in a second period that corresponds to a period after the first period by using the trained machine learning model.
